(19) United States
(12) Patent Application Publication
(10) Pub. No.: US 2015/0363848 A1
(43) Pub. Date: Dec. 17, 2015

(54) INTERNET SERVICE REGARDING AN AUTOMATED SYSTEM OF INTERACTIVE-BIDIRECTIONAL TRADE, IN REAL TIME, FOR TOURISM PRODUCTS-SERVICES

(71) Applicants: VASILIOS ZINAS, ATHENS (GR); LEONIDAS KARAKATSANIS, XANTHI (GR)

(72) Inventors: VASILIOS ZINAS, ATHENS (GR); LEONIDAS KARAKATSANIS, XANTHI (GR)

(21) Appl. No.: 13/261,956

(22) PCT Filed: Jun. 7, 2013
(86) PCT No.: PCT/GR2013/000032

§ 371 Date: Sep. 19, 2014

(51) Int. Cl. G06Q 30/06

(52) U.S. Cl. CPC G06Q 30/0609

(57) ABSTRACT

The present patent is referred to an innovative internet service regarding an interactive-bidirectional trade, in real time, for price negotiations of tourism products-services (accommodation, food, tickets, recreation activities or any other touristic product-service), correlating the offer of an amount of money from the user client-buyer, interested to buy the tourism product-service, with the offer of the user client-seller that provides the touristic product-service trying to meet the specifications set by the user client-buyer (regardless of what kind of software platform will be used). In this way the user client-buyer creates a business negotiating environment for tourism products-services that it starts from him, is customized at all levels by him and the final product of this procedure goes back to him.

The present patent is referred to an internet service regarding the trade and price negotiations of tourism products-services.

Tourism, worldwide, represents a major economic activity which often constitutes an important factor in the development of national economies of the countries. On the other hand, very often, are created distortions at the prices of tourism products-services due to the rotation of high and low touristic seasons, the existence of small or large companies providing tourism products-services, the great range of financial capabilities of the different clients-buyers of the tourism products-services and other factors. In addition, many times, even in the same geographical area there is a difficulty to operate the tourism market in the best and most rational way because of the lack of dynamic interactive trading of the tourism service-product between the interested parties, buyers and sellers.

The present patent is referred to an innovative internet service regarding an interactive-bidirectional automated trading system for price negotiations of tourism products-services (accommodation, food, tickets, recreation activities, or any other touristic product-service), correlating the offer of an amount of money from the user client-buyer, interested to buy the tourism product-service, with the offer of the user client-seller that provides the tourism product-service (regardless of what kind of software platform will be used). This system operates, in an automated way and in real time, without interfering users only by indicating the prices and the specifications of the tourism product-service. Initial offers of money from the user's client's-buyer's side have priority in the system.

An important advantage of the present patent is that the needs and requirements of the user buyer-client, for the tourism product-service that is looking for, are the central point of the system and also the user client-seller of the tourism product-service is trying to satisfy them through an internet service operating a real time automated system, of interactive-bidirectional trading of tourism products-services. From the research we have done so far we have not been able to find an internet service that meets these particular characteristics and mode of operation.

This particular internet service gives the opportunity to the user client-buyer to create a personal account to which is possible to commit, when the user client-buyer needs to use it, an amount of money that the user client-buyer intends to trade. This commitment of money into this personal account by the user client-buyer could be made by credit card or through direct deposit to an account of the company providing the internet service or through any other legal procedure. This personal account gives the possibility to the user client-buyer to use an internet environment that permits to the user client-buyer, in an absolutely detailed way, to determine the exact specifications of the tourism product that the user client-buyer intends to buy, with the amount of money that the user client-buyer has committed for this purpose, and to determine the price range within which the user buyer-client intends to trade. After the introduction of the amount of money in the account and its commitment, from the user client-buyer, the internet service develops, automatically, a web panel/table/list for the introduction of offers from the interested users clients-sellers of the tourism product-service visible, in real time, to all the interested users clients-sellers which they could desire to present an offer (on this panel/table/list) and the specifications of the user's client's-seller's offers are corresponding to the specifications of the user client-buyer. In this way is given the possibility to the user client-buyer to choose, automatically or manually, the best offer, within the price range, the time limit and the touristic product specifications that are determined by the user client-buyer. One characteristic of this internet service is that ensures through contracts or any other legal procedure and financial guarantees, according to the local national and international law that the users clients-sellers will meet the requirements and specifications as described at the user's client's-buyer's account and the web panel/table/list. If for any reason the trading will be judged unsuccessful the amount of money is returned immediately to an account of the user client-buyer.

1. The customer oriented, interactive-bidirectional trade internet based application, in real time, regarding the market of tourism products-services is characterized by the following steps:
Step 1: The user client-buyer creates a personal account through the interactive Internet application with the company that provides the internet service.
Step 2: The user client-buyer, when it will be necessary, commits the amount of money which intends to negotiate, by credit card or direct deposit or by any other lawful process, to the account of the company that provides the service the internet service.
Step 3: This account gives to the user client-buyer the opportunity to take advantage of a web environment that allows him to identify, with absolute precision the specifications of the tourism products-services that he intends to buy with the amount of money that is committed and possibly the range of amount of money within he intends to negotiate.
Step 4: With the commitment of the amount of money from the user client-buyer the application develops automatically a web panel/table/list (regardless of what kind of software platform will be used) visible in real time to all interested users clients-sellers, that they have an account with the company providing the internet service, for the introduction of offers of tourism products-services.
Step 5: The user client-buyer has the option to choose if the users client-sellers will have the opportunity to see or not to see, between them, their offers.
Step 6: The user client-buyer can choose the automatic selection of the best offer of tourism product-service setting filters that, in his opinion, will give him the best result or can choose the manual selection, within the price range and the time limit he has set.
Step 7: The company that provides the internet guarantees the transaction and ensures through contracts or any other legal form and also warranties, according to the local and international law, that the interested users clients-sellers will meet the specifications described in the user's client's-buyer's account. If for any reason the trading will be judged unsuccessful the amount of money is returned immediately to an account of the user client-buyer.
In this way the user client-buyer creates a business negotiating environment for tourism products-services that it starts from him, is customized at all levels by him and the final product of this procedure goes back to him.
